(19) United States
(12) Patent Application Publication
(10) Pub. No.: US 2025/0172853 A1
(43) Pub. Date: May 29, 2025

(54) APERTURE MODULE AND CAMERA MODULE INCLUDING APERTURE MODULE

(71) Applicant: Samsung Electro-Mechanics Co., Ltd., Suwon-si (KR)

(72) Inventors: Bo Sung SEO, Suwon-si (KR); Young Bok YOON, Suwon-si (KR); Kyung Hun LEE, Suwon-si (KR)

(73) Assignee: Samsung Electro-Mechanics Co., Ltd., Suwon-si (KR)

(21) Appl. No.: 18/931,200

(22) Filed: Oct. 30, 2024

(30) Foreign Application Priority Data
Nov. 24, 2023 (KR) 10-2023-0165174
Mar. 20, 2024 (KR) 10-2024-0038723

(51) Int. Cl. G03B 9/06

(52) U.S. Cl. CPC G03B 9/06

(57) ABSTRACT

An aperture module includes a base; a plurality of blades rotatably disposed on the base and forming an incident hole; and a moving portion configured to move relative to the base, wherein the moving portion includes a first moving frame and a second moving frame configured to move toward and away from each other, and a rotation axis of each of the plurality of blades moves together with the first moving frame and the second moving frame.

### CROSS-REFERENCE TO RELATED APPLICATIONS

This application claims the benefit under 35 USC 119(a) of Korean Patent Application Nos. 10-2023-0165174 filed on Nov. 24, 2023, and 10-2024-0038723 filed on Mar. 20, 2024, in the Korean Intellectual Property Office, the entire disclosures of which are incorporated herein by reference for all purposes.

### BACKGROUND

### 1. Field

The present disclosure relates to an aperture module and a camera module including an aperture module.

### 2. Description of Related Art

Recently, an aperture module for controlling an amount of light incident therethrough has been applied to a mobile camera module. The aperture module forms an incident hole through which light passes with a plurality of blades, and changes the size of the incident hole by moving the plurality of blades.

Additionally, recently, a camera module bending the path of light with a reflection module (hereinafter referred to as a ‘folded camera module) is being adopted for use in mobile devices. In a case of the folded camera module, a diameter of a lens module disposed in front of an image sensor is a factor affecting the thickness of the mobile device.

Additionally, by applying an aperture module to a folded camera module, a configuration of a plurality of blades forming an incident hole, and a driving portion moving the plurality of blades, may also be factors affecting the thickness of the mobile device.

Therefore, in the case of a folded camera module, it is difficult to apply an aperture module due to a limited space.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an aperture module includes a base; a plurality of blades rotatably disposed on the base and forming an incident hole; and a moving portion configured to move relative to the base, wherein the moving portion includes a first moving frame and a second moving frame configured to move toward and away from each other, and a rotation axis of each of the plurality of blades moves together with the first moving frame and the second moving frame.

A rotation axis of a portion of the plurality of blades may be disposed on the first moving frame, and a rotation axis of a remaining portion of the plurality of blades may be disposed on the second moving frame.

The first moving frame may include a first moving pin, the second moving frame may include a second moving pin, and the first moving pin and the second moving pin may form the rotation axis of each of the plurality of blades.

The first moving pin of the first moving frame and the second moving pin of the second moving frame may be disposed at respective positions not overlapping the incident hole in a direction perpendicular to a moving direction of the moving portion.

The respective positions at which the first moving pin of the first moving frame and the second moving pin of the second moving frame may be disposed may not overlap the incident hole in the moving direction of the moving portion.

The first moving pin of the first moving frame and the second moving pin of the second moving frame may be disposed at respective positions spaced apart from each other in a moving direction of the moving portion.

Each of the plurality of blades may include a rotation hole in which a respective one of the first moving pin and the second moving pin is disposed.

The base may include a fixed pin, and each of the plurality of blades may include a guide hole in which the fixed pin is disposed.

A distance between the moving pin and the incident hole may be less than a distance between the guide hole and the incident hole.

The guide hole may have a curved shape.

The base may include a fixed pin, the plurality of blades may be an even number of blades, one half of the even number of blades may be connected to the first moving pin of the first moving frame, a remaining one half of the even number of blades may be connected to the second moving pin of the second moving frame, and each of the plurality of blades may include a guide hole in which the fixed pin is disposed.

The plurality of blades may include a first blade, a second blade, a third blade, and a fourth blade, the first moving frame may include two first moving pins spaced apart from each other in a direction perpendicular to a moving direction of the first moving frame, the second moving frame may include two second moving pins spaced apart from each other in a direction perpendicular to a moving direction of the second moving frame, the two first moving pins may form a rotation axis of the first blade and a rotation axis of the second blade, and the two second moving pins may form a rotation axis of the third blade and a rotation axis of the fourth blade.

The aperture module may further include a first driving portion including a first magnet disposed on the first moving frame or the base, and a first coil disposed facing the first magnet; and a second driving portion including a second magnet disposed on the second moving frame or the base, and a second coil facing the second magnet.

The aperture module may further include a first ball member disposed between the first moving frame and the base; a second ball member disposed between the second moving frame and the base; and a pulling yoke portion including a first pulling yoke facing the first magnet, and a second pulling yoke facing the second magnet.

The plurality of blades may be configured to change a size of the incident hole as the plurality of blades rotate, and the incident hole may have an octagonal shape at a maximum size of the incident hole, and the incident hole may have a hexagonal shape at a minimum size of the incident hole.

In another general aspect, a camera module includes a lens module including a plurality of lenses; a reflection module disposed in front of or behind the lens module in an optical axis direction and including a reflection member configured to change a path of light; and an aperture module disposed between the lens module and the reflection module and including a base; a plurality of blades rotatably disposed on the base and forming an incident hole; and a first moving frame and a second moving frame configured to move relative to the base and toward and away from each other, wherein the first moving frame includes at least one first moving pin configured to move together with the first moving frame, the second moving frame includes at least one second moving pin configured to move together with the second moving frame, the at least one first moving pin forms a rotation axis of a portion of the plurality of blades, and the at least one second moving pin forms a rotation axis of a remaining portion of the plurality of blades.

The first moving pin and the second moving pin may be spaced apart from each other in a moving direction of the first moving frame and a moving direction of the second moving frame, and disposed at respective positions not overlapping the incident hole in a direction perpendicular to both the moving direction of the first moving frame and the moving direction of the second moving frame.

Each of the plurality of blades may include a guide hole having a curved shape, the base may include a fixed pin inserted into the guide hole of each of the plurality of blades, and the first moving pin and the second moving pin may be disposed closer to the incident hole than the fixed pin.

In another general aspect, an aperture module includes a base; a plurality of blades rotatably disposed on the base and forming an incident hole; and a plurality of moving pins forming rotation axes of the plurality of blades and configured to move in a straight line relative to the base to rotate the plurality of blades to change a size of the incident hole.

The base may include a plurality of fixed pins, each of the plurality of blades may include a rotation hole in which one of the plurality of moving pins is disposed, and each of the plurality of blades may include a guide hole in which one of the fixed pins is disposed.

A diameter of the rotation holes of the plurality of blades may be substantially equal to a diameter of the plurality of moving pins, a width of the guide holes of the plurality of blades may be substantially equal to a diameter of the plurality of fixed pins, and a length of the guide holes of the plurality of blades may be greater than a diameter of the plurality of fixed pins to enable the plurality of fixed pins to slide in the guide holes of the plurality of blades as the plurality of blades rotate to change the size of the incident hole.

The aperture module may further include a first moving frame and a second moving frame configured to move in straight lines relative to the base and toward and away from each other, a portion of the plurality of moving pins may be disposed on the first moving frame, and a remaining portion of the plurality of moving pins may be disposed on the second moving frame.

In another aspect, an aperture module includes a base; a plurality of blades rotatably disposed on the base and forming an incident hole; and a plurality of moving pins forming rotation axes of the plurality of blades and configured to move relative to the base to rotate the plurality of blades to change a size of the incident hole, wherein a portion of the plurality of moving pins is disposed on one side of the incident hole in a moving direction of the plurality of moving pins, and a remaining portion of the plurality of moving pins is disposed on an opposite side of the incident hole in the moving direction of the plurality of moving pins.

The base may include a plurality of fixed pins, each of the plurality of blades may include a rotation hole in which one of the plurality of moving pins is disposed, and each of the plurality of blades may include a guide hole in which one of the plurality of fixed pins is disposed.

The plurality of blades may include a first blade, a second blade, a third blade, and a fourth blade, the plurality of moving pins may include two first moving pins disposed on the one side of the incident hole in the moving direction of the plurality of moving pins, and two second moving pins disposed on the opposite side of the incident hole in the moving direction of the plurality of moving pins, a first one of the two first moving pin may form the rotation axis of the first blade, a second one of the two first moving pins may form the rotation axis of the second blade, a first one of the two second moving pins may form the rotation axis of the third blade, a second one of the two second moving pins may form the rotation axis of the fourth blade, the two first moving pins may be spaced apart from each other in a direction perpendicular to the moving direction of the plurality of moving pins, the two second moving pins may be spaced apart from each other in a direction perpendicular to the moving direction of the plurality of moving pins, and the two first moving pins and the two second moving pins may not overlap the incident hole in the moving direction of the plurality of moving pins.

The plurality of blades may include a first blade, a second blade, a third blade, and a fourth blade, the plurality of moving pins may include a first moving pin disposed on the one side of the incident hole in the moving direction of the plurality of moving pins, and a second moving pin disposed on the opposite side of the incident hole in the moving direction of the plurality of moving pins, the first moving pin may form the rotation axis of the first blade and the rotation axis of the second blade, the second moving pin may form the rotation axis of the third blade and the rotation axis of the fourth blade, and the first moving pin and the second moving pin may overlap the incident hole in the moving direction of the plurality of moving pins.

Other features and aspects will be apparent from the following detailed description, the drawings, and the claims.

### BRIEF DESCRIPTION OF DRAWINGS

FIG. 1 is a perspective view of an aperture module according to an embodiment of the present disclosure.

FIG. 2 is a perspective view of the aperture module of FIG. 1 viewed from below.

FIG. 3 is an exploded perspective view of the aperture module of FIGS. 1 and 2.

FIG. 4 is a partially exploded perspective view of the aperture module of FIGS. 1 to 3.

FIG. 5 is a partially exploded perspective view of the aperture module of FIGS. 1 to 3 viewed from below.

FIG. 6 is a bottom view illustrating a state in which an incident hole of the aperture module of FIGS. 1 to 5 has a maximum size.

FIG. 7 is a bottom view illustrating a state in which the incident hole of the aperture module of FIGS. 1 to 5 has a minimum size.

FIG. 8 is an exploded perspective view of an aperture module according to another embodiment of the present disclosure.

FIG. 9 is a bottom view illustrating a state in which an incident hole of the aperture module of FIG. 8 has a maximum size.

FIG. 10 is a bottom view illustrating a state in which the incident hole of the aperture module of FIG. 8 has a minimum size.

FIG. 11 is a schematic perspective view of a camera module according to an embodiment of the present disclosure.

FIG. 12 is a schematic perspective view of a camera module according to another embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

A camera module according to embodiments of the present disclosure may be mounted in portable electronic devices. Portable electronic devices may include a mobile communication terminal, a smartphone, a tablet PC, or other portable electronic device.

In this specification, an optical axis (Z-axis) direction may refer to a direction in which light is incident on an aperture module.

In addition, a first axis (X-axis) direction and a second axis (Y-axis) direction are examples of two directions that are perpendicular to the optical axis (Z-axis) and intersect each other. In this specification, the first axis (X-axis) direction and the second axis (Y-axis) direction may be understood as two directions that are perpendicular to the optical axis (Z-axis) and intersect each other.

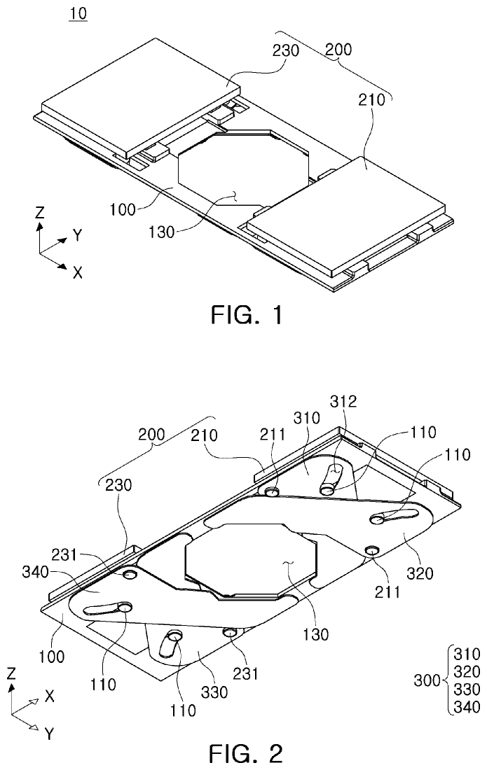

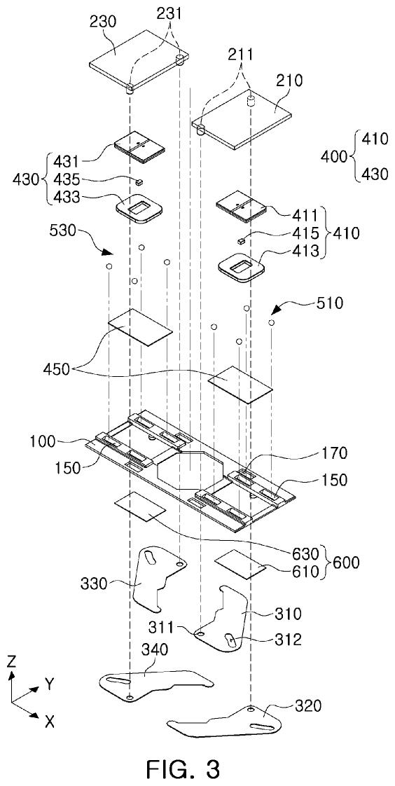

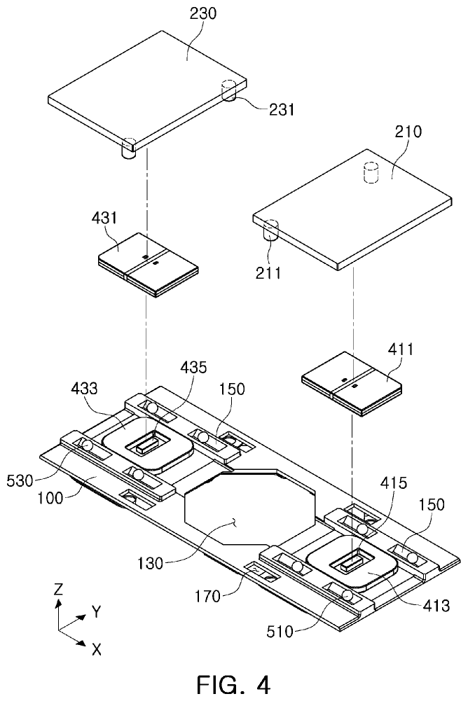

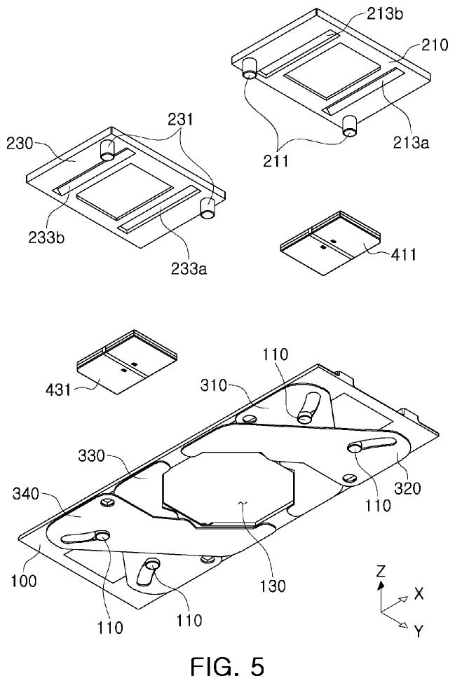

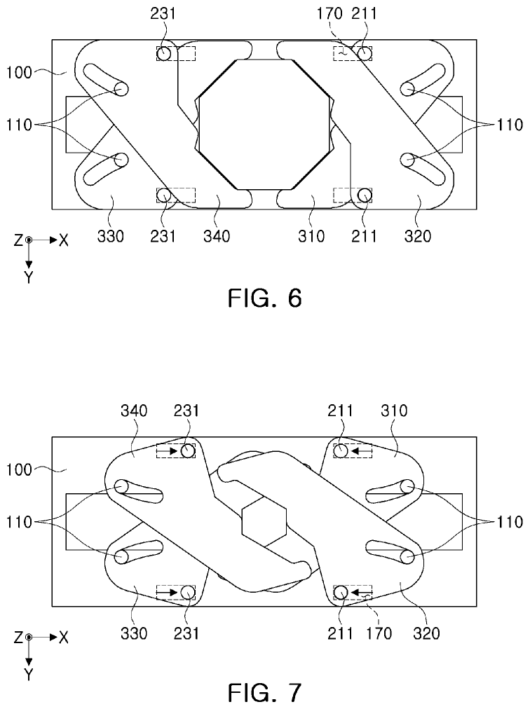

FIG. 1 is a perspective view of an aperture module according to an embodiment of the present disclosure. FIG. 2 is a perspective view of the aperture module of FIG. 1 viewed from below. FIG. 3 is an exploded perspective view of the aperture module of FIGS. 1 and 2. FIG. 4 is a partially exploded perspective view of the aperture module of FIGS. 1 to 3. FIG. 5 is a partially perspective view of the aperture module of FIGS. 1 to 3 viewed from below. FIG. 6 is a bottom view illustrating a state in which an incident hole of the aperture module of FIGS. 1 to 5 has a maximum size. FIG. 7 is a bottom view illustrating a state in which the incident hole of the aperture module of FIGS. 1 to 5 has a minimum size.

Referring to FIGS. 1 to 7, an aperture module 10 according to an embodiment of the present disclosure includes a base 100, a plurality of blades 300, and a moving portion 200.

The base 100 may have a rectangular plate shape with an incident hole 130 in the center. The incident hole 130 may have an octagonal shape.

The moving portion 200 may be configured to be movable relative to the base 100. The moving portion 200 may include a plurality of moving frames configured to be movable, and the plurality of moving frames may be spaced apart from one surface of the base 100. The moving portion 200 may be moved relative to the base 100 in a first axis (X-axis) direction.

The plurality of moving frames may include a first moving frame 210 and a second moving frame 230.

The first moving frame 210 and the second moving frame 230 may be moved toward or away from each other. For example, the first moving frame 210 and the second moving frame 230 may be moved toward or away from each other in the first axis (X-axis) direction.

The plurality of blades 300 may each be rotatably disposed on the base 100. The plurality of blades 300 may be disposed on the other surface of the base 100 (a surface opposite to the one surface of the base 100).

The plurality of blades 300 may form the incident hole 130. The plurality of blades 300 may include an even number of blades. In an embodiment, the plurality of blades 300 may include a first blade 310, a second blade 320, a third blade 330, and a fourth blade 340. In this embodiment, a total of four blades may be provided, but the number of the plurality of blades 300 is not limited thereto.

The incident hole 130 may be defined by the surfaces of the plurality of blades 300 facing an optical axis (Z-axis) (or the center of the incident hole 130). A position of each of the plurality of blades 300 may be changed by a driving unit 400. Accordingly, the size of the incident hole 130 may change depending on the position of each of the plurality of blades 300. For example, the size of the incident hole 130 may decrease or increase as each of the plurality of blades 300 rotates.

The incident hole 130 may have an octagonal shape at a maximum size of the incident hole 130 as illustrated in FIG. 6, and the incident hole 130 may have a hexagonal shape at a minimum size of the incident hole 130 as illustrated in FIG. 7.

The plurality of blades 300 are each connected to the base 100 and the moving portion 200.

For example, the base 100 may include a plurality of fixed pins 110. The plurality of fixed pins 110 may protrude from the other surface of the base 100. The plurality of blades 300 may be respectively connected to the plurality of fixed pins 110 of the base 100. For example, the first to fourth blades 310, 320, 330, and 340 may be respectively connected to the plurality of fixed pins 110 of the base 100.

A number of the plurality of fixed pins 110 of the base 100 may be equal to a number of the plurality of blades 300. For example, when the aperture module 10 includes four blades, the base 100 may have four fixed pins 110. In an embodiment, the base 100 may include a first fixed pin, a second fixed pin, a third fixed pin, and a fourth fixed pin.

The first blade 310 may be connected to the first fixed pin of the base 100, the second blade 320 may be connected to the second fixed pin of the base 100, the third blade 330 may be connected to the base 100, and the fourth blade 340 may be connected to the fourth fixed pin of the base 100.

The moving portion 200 may include a moving pin 211 and a moving pin 231. The moving pins 211 and 231 may protrude from one surface of the moving portion 200 (the surface facing the one surface of the base 100). The moving pins 211 and 231 of the moving portion 200 may form rotation axes of the plurality of blades 300 so that the rotation axis of each blade may move together with the moving portion 200. The plurality of blades 300 may be connected to the moving pins 211 and 231, respectively. For example, the first to fourth blades 310, 320, 330, and 340 may be connected to the moving pins 211 and 231 of the moving portion 200, respectively.

The first moving frame 210 and the second moving frame 230 each include a moving pin. In an embodiment, the first moving frame 210 may include one or more first moving pins 211, and the second moving frame 230 may include one or more second moving pins 231.

The first moving pin 211 of the first moving frame 210 may form a rotation axis of a portion of the plurality of blades 300. The second moving pin 231 of the second moving frame 230 may form a rotation axis of a remaining portion of the plurality of blades 300. For example, half of the plurality of blades 300 may be connected to the first moving pin 211 of the first moving frame 210, and the other half of the plurality of blades 300 may be connected to the second moving pin 231 of the second moving frame 230.

In an embodiment, the first moving frame 210 may include two first moving pins 211. The first blade 310 may be connected to one of the two first moving pins 211, and the second blade 320 may be connected to the other one of the two first moving pins 211. The second moving frame 230 may include two second moving pins 231. The third blade 330 may be connected to one of the two second moving pins 231, and the fourth blade 340 may be connected to the other one of the two second moving pins 231.

The two first moving pins 211 may be spaced apart from each other in a direction (a second axis (Y-axis) direction) perpendicular to a moving direction (the first axis (X-axis) direction) of the moving portion 200 on the first moving frame 210, and the two second moving pins 231 may be spaced apart from each other in the direction (the second axis (Y-axis) direction) perpendicular to the moving direction (the first axis (X-axis) direction) of the moving portion 200 on the second moving frame 230. The two first moving pins 211 and the two second moving pins 231 may be spaced apart from each other in the moving direction (the first axis (X-axis) direction) of the moving portion 200.

Through-holes 170 penetrating the base 100 may be formed in the base 100, and the two first moving pins 211 and the two second moving pins 231 of the moving portion 200 may pass through respective ones of the through-holes 170 and protrude from the other surface of the base 100.

The through-holes 170 may be disposed further outside in the second axis (Y-axis) direction than guide grooves 150 of the base 100 to be described later.

The plurality of blades 300 may be disposed on the other surface of the base 100. Each of the plurality of blades 300 may be connected to a respective one of the fixed pins 110 on the other surface of the base 100 and a respective one of the moving pins 211 and 231 of the moving portion 200 protruding from the other surface of the base 100.

Since each of the plurality of blades 300 may be connected to the base 100 and the moving portion 200 in the same way, the connection of one of the plurality of blades 300 will be described below.

The first blade 310 may include a rotation hole 311. The rotation hole 311 may be a hole penetrating the first blade 310. The first moving pin 211 of the first moving frame 210 may be disposed in the rotation hole 311. The first moving pin 211 may have a cylindrical shape. A diameter of the first moving pin 211 may be substantially equal to a diameter of the rotation hole 311.

The first blade 310 may be rotated using the first moving pin 211 as a rotation axis when the first moving pin 211 is moved together with the first moving frame 210. In the embodiment, the first moving pin 211 forming a rotation axis of the first blade 310 may be a moving member. Accordingly, the first blade 310 may move together with the first moving frame 210 as the first moving frame 210 moves.

The first blade 310 may include a guide hole 312. The guide hole 312 may be a hole penetrating the first blade 310. The guide hole 312 may be disposed at a position spaced apart from the rotation hole 311. The fixed pin 110 of the base 100 may be disposed in the guide hole 312. The fixed pin 110 may have a cylindrical shape. The guide hole 312 may have a larger size than the fixed pin 110. For example, a width of the guide hole 312 may be substantially equal to a diameter of the fixed pin 110, and a length of the guide hole 312 may be larger than the diameter of the fixed pin 110. Additionally, the guide hole 312 may have a curved shape.

A shape of the guide hole 312 is not limited to the shape shown in the drawings. For example, as long as the shape of the guide hole 312 allows the first blade 310 to rotate in conjunction with the movement of the moving portion 200, the shape of the guide hole 312 may be changed.

As the first moving frame 210 and the first moving pin 211 move, the guide hole 312 of the first blade 310 may move while being guided by the first fixed pin 110 of the base 100. Accordingly, the first blade 310 may be moved while rotating about the first moving pin 211 as a rotation axis.

The first moving pin 211 may be disposed closer to the incident hole 130 than the fixed pin 110.

The first moving pin 211 and the second moving pin 231 may be disposed at positions not overlapping the incident hole 130 in a direction perpendicular to the moving direction of the moving portion 200.

Additionally, the first moving pin 211 and the second moving pin 231 may be disposed at positions not overlapping the incident hole 130 in the moving direction of the moving portion 200.

The aperture module 10 may include the driving unit 400. The driving unit 400 may include a first driving portion 410 and a second driving portion 430.

Referring to FIGS. 3 to 5, the first driving portion 410 may include a first magnet 411 and a first coil 413. The first magnet 411 and the first coil 413 may be disposed to face each other in the optical axis (Z-axis) direction. The optical axis (Z-axis) direction may be a direction in which light may be incident on the incident hole 130.

The first magnet 411 may be disposed on one of the base 100 and the moving portion 200, and the first coil 413 may be disposed on the other one of the base 100 and the moving portion 200. Hereinafter, the description will be based on an embodiment in which the first magnet 411 may be disposed on the first moving frame 210 and the first coil 413 may be disposed on the base 100.

The first magnet 411 may be disposed on the first moving frame 210, and the first coil 413 may be disposed on the base 100.

The first magnet 411 may be magnetized so that one surface (the surface facing the first coil 413) may have both an N pole and an S pole. As an example, on the one surface of the first magnet 411 facing the first coil 413, an N pole, a neutral region, and an S pole may be formed sequentially along a direction perpendicular to the optical axis (Z-axis) (e.g., the moving direction of the moving portion 200).

The first coil 413 may be disposed to face the first magnet 411. For example, the first coil 413 may be disposed to face the first magnet 411 in the optical axis (Z-axis) direction.

The first coil 413 may be disposed on a substrate 450, and the substrate 450 may be mounted on the base 100 so that the first magnet 411 and the first coil 413 face each other in the optical axis (Z-axis) direction. As an example, the first coil 413 may be disposed on one surface of the substrate 450. The substrate 450 may be mounted on the base 100.

The first magnet 411 may be a moving member mounted on the moving portion 200 and move together with the moving portion 200, and the first coil 413 may be a fixed member fixed to the base 100.

When power is applied to the first coil 413, the first moving frame 210 may be moved by an electromagnetic force generated between the first magnet 411 and the first coil 413.

The second driving portion 430 may include a second magnet 431 and a second coil 433. The second magnet 431 and the second coil 433 may be disposed to face each other in the optical axis (Z-axis) direction. The optical axis (Z-axis) direction may be a direction in which light is incident on the incident hole 130.

The second magnet 431 may be disposed on one of the base 100 and the moving portion 200, and the second coil 433 may be disposed on the other one of the base 100 and the moving portion 200. Hereinafter, the description will be based on an embodiment in which the second magnet 431 is disposed on the second moving frame 230 and the second coil 433 is disposed on the base 100.

The second magnet 431 may be disposed on the second moving frame 230, and the second coil 433 may be disposed on the base 100.

The second magnet 431 may be magnetized so that one surface (the surface facing the second coil 433) may have both an N pole and an S pole. As an example, on the one surface of the second magnet 431 facing the second coil 433, an N pole, a neutral region, and an S pole may be sequentially formed along a direction perpendicular to the optical axis (Z-axis) (e.g., the moving direction of the moving portion 200).

The second coil 433 may be disposed to face the second magnet 431. For example, the second coil 433 may be disposed to face the second magnet 431 in the optical axis (Z-axis) direction.

The second coil 433 may be disposed on the substrate 450, and the substrate 450 may be mounted on the base 100 so that the second magnet 431 and the second coil 433 face each other in the optical axis (Z-axis) direction. As an example, the second coil 433 may be disposed on one surface of the substrate 450. The substrate 450 may be mounted on the base 100.

The second magnet 431 may be a moving member that is mounted on the moving portion 200 and moves together with the moving portion 200, and the second coil 433 may be a fixed member fixed to the base 100.

When power is applied to the second coil 433, the second moving frame 230 may be moved by an electromagnetic force generated between the second magnet 431 and the second coil 433.

The first magnet 411 and the second magnet 431 may be spaced apart in a direction perpendicular to the optical axis (Z-axis) (e.g., the moving direction of the moving portion 200). Additionally, the first coil 413 and the second coil 433 may be spaced apart in a direction perpendicular to the optical axis (Z-axis) (e.g., the moving direction of the moving portion 200).

The first moving frame 210 and the second moving frame 230 may be moved toward or away from each other by the driving unit 400.

A plurality of ball members may be disposed between the base 100 and the moving portion 200. The plurality of ball members may be disposed between the base 100 and the moving portion 200 to reduce friction when the moving portion 200 is moved. The plurality of ball members may include a first ball member 510 and a second ball member 530.

The first ball member 510 may be disposed between the base 100 and the first movable frame 210, and the second ball member 530 may be disposed between the base 100 and the second movable frame 230. The first ball member 510 and the second ball member 530 each include a plurality of balls. In an embodiment, the first ball member 510 may include three or more balls and the second ball member 530 may include three or more balls. FIGS. 3 and 4 illustrate an embodiment in which the first ball member 510 and the second ball member 530 each include four balls.

Guide grooves may be formed in surfaces of the base 100 and the moving portion 200 facing each other. For example, guide grooves 150 may be formed in one surface of the base 100, guide grooves 213a and 213b may be formed in one surface of the first moving frame 210, and guide grooves 233a and 233b may be formed in one surface of the second moving frame 230.

The guide grooves 150 of the base 100 and the guide grooves 213a, 213b, 233a, and 233b of the moving portion 200 may face each other in the optical axis (Z-axis) direction.

The plurality of ball members are disposed between the guide grooves 150 of the base 100 and the guide grooves 213a, 213b, 233a, and 233b of the moving portion 200. Each guide groove 150 may have a shape having a length in the moving direction of the moving portion 200. The plurality of ball members may roll when the moving portion 200 moves.

The first moving frame 210 may include the plurality of guide grooves 213a and 213b spaced apart in the second axis (Y-axis) direction. Among the plurality of guide grooves 213a and 213b, the guide groove 213a disposed in the positive direction (+Y-axis direction) of the second axis (Y-axis) may be in two-point contact with two of the plurality of balls of the first ball member 510. Among the plurality of guide grooves 213a and 213b, the guide groove 213b disposed in the negative direction (−Y-axis direction) of the second axis (Y-axis) may be in one-point contact with the remaining two of the plurality of balls of the first ball member 510. Additionally, each of the plurality of balls of the first ball member 510 may be in two-point contact with a respective one of the guide grooves 150 of the base 100.

In another embodiment, four of the guide grooves 150 may be formed in the first moving frame 210, and the plurality of guide grooves 213a and 213b may be formed in the base 100.

The second moving frame 230 may include the plurality of guide grooves 233a and 233b spaced apart in the second axis (Y-axis) direction. Among the plurality of guide grooves 233a and 233b, the guide groove 233a disposed in the positive direction (+Y-axis direction) of the second axis (Y-axis) may be in one-point contact with two of the plurality of balls of the second ball member 530. Among the plurality of guide grooves 233a and 233b, the guide groove 233b disposed in the negative direction (−Y-axis direction) of the second axis (Y-axis) may be in two-point contact with the remaining two of the plurality of balls of the first ball member 510. Additionally, the plurality of balls of the second ball member 530 may each be in two-point contact with a respective one of the guide grooves 150 of the base 100.

In another embodiment, four of the guide grooves 150 may be formed in the second moving frame 220, and the plurality of guide grooves 233a and 233b may be formed in the base 100.

In an embodiment, the first magnet 411 may be disposed closer to the guide groove 213a disposed in the positive direction (+Y-axis direction) of the second axis (Y-axis) among the plurality of guide grooves 213a and 213b of the first moving frame 210. Also, the second magnet 431 may be disposed closer to the guide groove 233b disposed in the negative direction (−Y-axis direction) of the second axis (Y-axis) among the plurality of guide grooves 233a and 233b of the second moving frame 230.

That is, when viewed from the first axis (X-axis) direction, the center of the first magnet 411 and the center of the second magnet 431 may be spaced apart.

A pulling yoke portion 600 may be disposed on the base 100. The pulling yoke portion 600 may be disposed at a position facing the first magnet 411 and the second magnet 431 in the optical axis (Z-axis) direction.

The pulling yoke portion 600 may be disposed on the other surface of the substrate 450.

The pulling yoke portion 600 and the first magnet 411, and the pulling yoke portion 600 and the second magnet 431, may generate an attractive force between each other.

The pulling yoke portion 600 may include a first pulling yoke 610 and a second pulling yoke 630. The first pulling yoke 610 may face the first magnet 411 in the optical axis (Z-axis) direction, and the second pulling yoke 630 may face the second magnet 431 in the optical axis (Z-axis) direction. The first pulling yoke 610 and the second pulling yoke 630 may be made of a magnetic material.

An attractive force may act in the optical axis (Z-axis) direction between the first pulling yoke 610 and the first magnet 411, and between the second pulling yoke 630 and the second magnet 431.

Accordingly, the moving portion 200 is pressed in a direction toward the base 100 by the attractive force between the first pulling yoke 610 and the first magnet 411, and between the second pulling yoke 630 and the second magnet 431, the base 100 and the moving portion 200 may maintain contact with the plurality of ball members of the first ball member 510 and the second ball member 520.

The aperture module 10 may detect the position of the moving portion 200. For this purpose, the aperture module 10 may include a position sensor portion. The position sensor portion may include a first position sensor 415 and a second position sensor 435.

The first position sensor 415 may be disposed on the substrate 450 to face the first magnet 411, and the second position sensor 435 may be disposed on the substrate 450 to face the second magnet 431.

The first position sensor 415 and the second position sensor 435 may each be a Hall sensor.

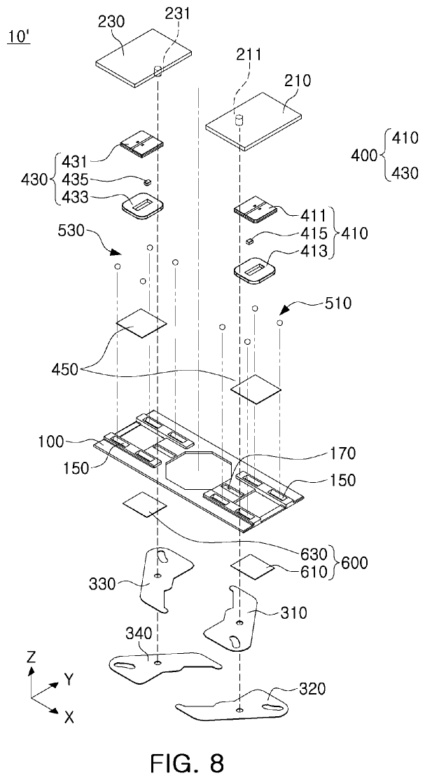

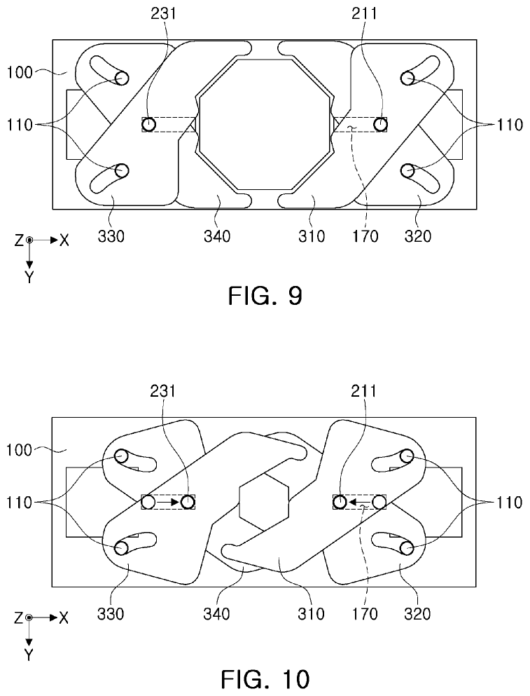

FIG. 8 is an exploded perspective view of an aperture module according to another embodiment of the present disclosure, FIG. 9 is a bottom view illustrating a state in which an incident hole of the aperture module has a maximum size, and FIG. 10 is a bottom view illustrating a state in which the incident hole of the aperture module of FIG. 8 has a minimum size.

Referring to FIG. 8, an aperture module 10′ according to the other embodiment of the present disclosure differs from the embodiment illustrated in FIGS. 1 to 7 in the first moving pin 211 of the first moving frame 210 and the second moving pin 231 of the second moving frame 230.

The first moving frame 210 in the embodiment illustrated in FIG. 8 may have one first moving pin 211, rather than two first moving pins 211 as in the embodiment illustrated in FIGS. 1 to 7, and the second moving frame 230 in the embodiment illustrated in FIG. 8 may have one second moving pin 231, rather than two second moving pins 231 as in the embodiment illustrated in FIGS. 1 to 7. The first moving pin 211 and the second moving pin 231 may be spaced apart in the first axis (X-axis) direction with the incident hole 130 interposed therebetween.

The first moving pin 211 and the second moving pin 231 may be disposed at respective positions not overlapping the incident hole 130 in the second axis (Y-axis) direction.

The first moving pin 211 of the first moving frame 210 may form a rotation axis of a portion of the plurality of blades 300. The second moving pin 231 of the second moving frame 230 may form ta rotation axis of a remaining portion of the plurality of blades 300. For example, half of the plurality of blades 300 may be connected to the first moving pin 211 of the first moving frame 210, and the other half of the plurality of blades 300 may be connected to the second moving pin 231 of the second moving frame 230.

The first moving pin 211 of the first moving frame 210 may be connected to the first blade 310 and the second blade 320. Also, the second moving pin 231 of the second moving frame 230 may be connected to the third blade 330 and the fourth blade 340. That is, referring to FIG. 8, the rotation axis of the first blade 310 and the rotation axis of the second blade 320 may be the same. Also, the rotation axis of the third blade 330 and the rotation axis of the fourth blade 340 may be the same.

Through-holes 170 passing through the base 100 may be formed in the base 100, and the first moving pin 211 and the second moving pin 231 may pass through respective ones of the through-holes 170 and protrude from the other surface of the base 100.

As the first moving frame 210 and the first moving pin 211 move, the first blade 310 and the second blade 320 may be moved while rotating about the first moving pin 211 as a rotation axis. Moreover, as the second moving frame 230 and the second moving pin 231 move, the third blade 330 and the fourth blade 340 may be moved while rotating about the second moving pin 231 as a rotation axis.

The incident hole 130 may be defined by the surfaces of the plurality of blades 300 facing an optical axis (Z-axis) (or the center of the incident hole 130). A position of each of the plurality of blades 300 may be changed by a driving unit 400. Accordingly, the size of the incident hole 130 may change depending on the position of each of the plurality of blades 300. For example, the size of the incident hole 130 may decrease or increase as each of the plurality of blades 300 rotates.

The incident hole 130 may have an octagonal shape at a maximum size of the incident hole 130 as illustrated in FIG. 9, and the incident hole 130 may have a hexagonal shape at a minimum size of the incident hole 130 as illustrated in FIG. 10.

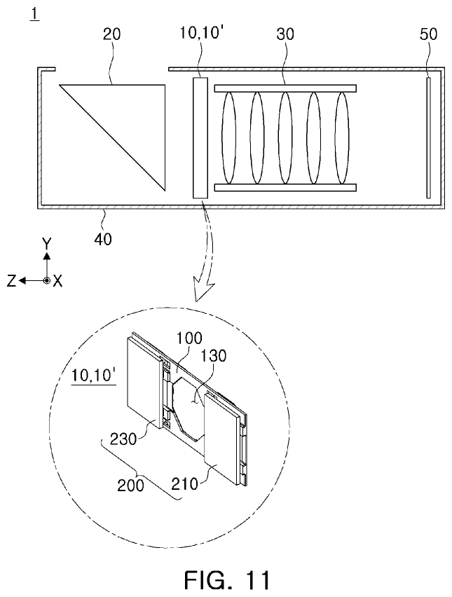

FIG. 11 is a schematic perspective view of a camera module according to an embodiment of the present disclosure.

Referring to FIG. 11, a camera module 1 according to an embodiment of the present disclosure may include a reflection module 20, a lens module 30, and an aperture module 10, and may further include a housing 40. In addition, the camera module 1 may further include an image sensor 50 disposed in the housing 40.

In this embodiment, an optical axis (Z-axis) of the lens module 30 is perpendicular to a thickness direction of a portable electronic device in which the camera module 1 is mounted (a direction from a front surface of the portable electronic device to a rear surface of the portable electronic device or an opposite direction).

For example, the optical axis (Z-axis) of the lens module 30 may be oriented in a width direction or a length direction of the portable electronic device. In the camera module 1 of this embodiment, the optical axis (Z-axis) of the lens module 30 is oriented in the width direction or the length direction of the portable electronic device, thereby reducing the thickness of the portable electronic device.

The reflection module 20 and the lens module 30 may be disposed inside the housing 40 as illustrated in FIG. 11. However, it may be also possible to dispose the reflection module 20 and the lens module 30 in separate housings and combine the housings with each other.

The reflection module 20 may be disposed in front of the lens module 30. The reflection module 20 may be configured to change a direction of light. For example, the direction of light incident into the housing 40 may be changed to head toward the lens module 30 through the reflection module 20. The reflection module 20 may include a reflection member that reflects light. The reflection member may be a mirror or prism.

The aperture module 10 illustrated in FIGS. 1 to 7 or the aperture module 10′ illustrated in FIGS. 8-10 may be disposed between the reflection module 20 and the lens module 30. That is, in the embodiment of FIG. 11, the reflection module 20, the aperture module 10 or 10′, and the lens module 30 may be arranged in order along a direction of light travel.

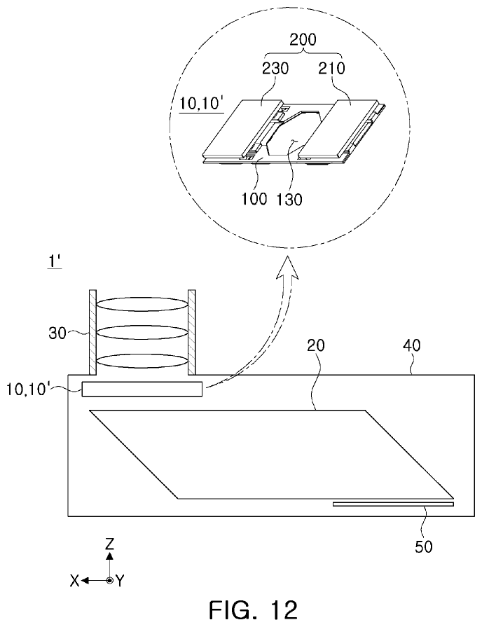

FIG. 12 is a schematic perspective view of a camera module according to another embodiment of the present disclosure.

Referring to FIG. 12, a camera module 1′ according to another embodiment of the present disclosure may include a reflection module 20, a lens module 30, and an aperture module 10, and may further include a housing 40. In addition, it may further include an image sensor 50 disposed in the housing 40.

In this embodiment, an optical axis (Z-axis) of the lens module 30 may be oriented in the thickness direction of a portable electronic device in which the camera module 1′ is mounted (a direction from a front surface of the portable electronic device to a rear surface of the portable electronic device or an opposite direction).

The lens module 30 and the reflection module 20 may be disposed inside the housing 40. However, it is also possible to dispose the lens module 30 and the reflection module 20 in separate housings and combine the housings with each other.

The reflection module 20 may be disposed behind the lens module 30. Accordingly, the embodiment illustrated in FIG. 12 may reduce an Fno (f-number) of the camera module 1′.

The reflection module 20 may be configured to change the direction of light. For example, a direction of light passing through the lens module 30 may be changed by the reflection module 20. The reflection module 20 may include a reflection member that reflects light. The reflection member may be a mirror or prism.

The aperture module 10 illustrated in FIGS. 1 to 7 or the aperture module 10′ illustrated in FIGS. 8-10 may be disposed between the lens module 30 and the reflection module 20.

That is, in the embodiment of FIG. 12, the lens module 30, the aperture module 10 or 10′, and the reflection module 20 may be arranged in order along a direction of light travel.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An aperture module comprising:
a base;
a plurality of blades rotatably disposed on the base and forming an incident hole; and
a moving portion configured to move relative to the base,
wherein the moving portion comprises a first moving frame and a second moving frame configured to move toward and away from each other, and
a rotation axis of each of the plurality of blades moves together with the first moving frame and the second moving frame.

2. The aperture module of claim 1, wherein a rotation axis of a portion of the plurality of blades is disposed on the first moving frame, and a rotation axis of a remaining portion of the plurality of blades is disposed on the second moving frame.

3. The aperture module of claim 1, wherein the first moving frame comprises a first moving pin,
the second moving frame comprises a second moving pin, and
the first moving pin and the second moving pin form the rotation axis of each of the plurality of blades.

4. The aperture module of claim 3, wherein the first moving pin of the first moving frame and the second moving pin of the second moving frame are disposed at respective positions not overlapping the incident hole in a direction perpendicular to a moving direction of the moving portion.

5. The aperture module of claim 4, wherein the respective positions at which the first moving pin of the first moving frame and the second moving pin of the second moving frame are disposed do not overlap the incident hole in the moving direction of the moving portion.

6. The aperture module of claim 3, wherein the first moving pin of the first moving frame and the second moving pin of the second moving frame are disposed at respective positions spaced apart from each other in a moving direction of the moving portion.

7. The aperture module of claim 3, wherein each of the plurality of blades comprises a rotation hole in which a respective one of the first moving pin and the second moving pin is disposed.

8. The aperture module of claim 3, wherein the base comprises a fixed pin, and each of the plurality of blades comprises a guide hole in which the fixed pin is disposed.

9. The aperture module of claim 8, wherein a distance between the moving pin and the incident hole is less than a distance between the guide hole and the incident hole.

10. The aperture module of claim 8, wherein the guide hole has a curved shape.

11. The aperture module of claim 3, wherein the base comprises a fixed pin,
the plurality of blades are an even number of blades,
one half of the even number of blades are connected to the first moving pin of the first moving frame,
a remaining one half of the even number of blades are connected to the second moving pin of the second moving frame, and
each of the plurality of blades comprises a guide hole in which the fixed pin is disposed.

12. The aperture module of claim 1, wherein the plurality of blades comprise a first blade, a second blade, a third blade, and a fourth blade,
the first moving frame comprises two first moving pins spaced apart from each other in a direction perpendicular to a moving direction of the first moving frame,
the second moving frame comprises two second moving pins spaced apart from each other in a direction perpendicular to a moving direction of the second moving frame,
the two first moving pins form a rotation axis of the first blade and a rotation axis of the second blade, and
the two second moving pins form a rotation axis of the third blade and a rotation axis of the fourth blade.

13. The aperture module of claim 1, further comprising:
a first driving portion comprising a first magnet disposed on the first moving frame or the base, and a first coil disposed facing the first magnet; and
a second driving portion comprising a second magnet disposed on the second moving frame or the base, and a second coil facing the second magnet.

14. The aperture module of claim 13, further comprising:
a first ball member disposed between the first moving frame and the base;
a second ball member disposed between the second moving frame and the base; and
a pulling yoke portion comprising a first pulling yoke facing the first magnet, and a second pulling yoke facing the second magnet.

15. The aperture module of claim 1, wherein the plurality of blades are configured to change a size of the incident hole as the plurality of blades rotate, and
the incident hole has an octagonal shape at a maximum size of the incident hole, and
the incident hole has a hexagonal shape at a minimum size of the incident hole.

16. A camera module comprising:
a lens module comprising a plurality of lenses;
a reflection module disposed in front of or behind the lens module in an optical axis direction and comprising a reflection member configured to change a path of light; and
an aperture module disposed between the lens module and the reflection module and comprising:
a base;
a plurality of blades rotatably disposed on the base and forming an incident hole; and
a first moving frame and a second moving frame configured to move relative to the base and toward and away from each other,
wherein the first moving frame comprises at least one first moving pin configured to move together with the first moving frame,
the second moving frame comprises at least one second moving pin configured to move together with the second moving frame, and
the at least one first moving pin forms a rotation axis of a portion of the plurality of blades, and the at least one second moving pin forms a rotation axis of a remaining portion of the plurality of blades.

17. The camera module of claim 16, wherein the first moving pin and the second moving pin are:
spaced apart from each other in a moving direction of the first moving frame and a moving direction of the second moving frame, and
disposed at respective positions not overlapping the incident hole in a direction perpendicular to both the moving direction of the first moving frame and the moving direction of the second moving frame.

18. The camera module of claim 16, wherein each of the plurality of blades comprises a guide hole having a curved shape,
the base comprises a fixed pin inserted into the guide hole of each of the plurality of blades, and
the first moving pin and the second moving pin are disposed closer to the incident hole than the fixed pin.

19. An aperture module comprising:
a base;
a plurality of blades rotatably disposed on the base and forming an incident hole; and
a plurality of moving pins forming rotation axes of the plurality of blades and configured to move in a straight line relative to the base to rotate the plurality of blades to change a size of the incident hole.

20. The aperture module of claim 19, wherein the base comprises a plurality of fixed pins,
each of the plurality of blades comprises a rotation hole in which one of the plurality of moving pins is disposed, and
each of the plurality of blades comprises a guide hole in which one of the fixed pins is disposed.

21. The aperture module of claim 20, wherein a diameter of the rotation holes of the plurality of blades is substantially equal to a diameter of the plurality of moving pins,
a width of the guide holes of the plurality of blades is substantially equal to a diameter of the plurality of fixed pins, and
a length of the guide holes of the plurality of blades is greater than a diameter of the plurality of fixed pins to enable the plurality of fixed pins to slide in the guide holes of the plurality of blades as the plurality of blades rotate to change the size of the incident hole.

22. The aperture module of claim 19, further comprising a first moving frame and a second moving frame configured to move in straight lines relative to the base and toward and away from each other,
a portion of the plurality of moving pins is disposed on the first moving frame, and
a remaining portion of the plurality of moving pins is disposed on the second moving frame.

23. An aperture module comprising:
a base;
a plurality of blades rotatably disposed on the base and forming an incident hole; and
a plurality of moving pins forming rotation axes of the plurality of blades and configured to move relative to the base to rotate the plurality of blades to change a size of the incident hole,
wherein a portion of the plurality of moving pins is disposed on one side of the incident hole in a moving direction of the plurality of moving pins, and a remaining portion of the plurality of moving pins is disposed on an opposite side of the incident hole in the moving direction of the plurality of moving pins.

24. The aperture module of claim 23, wherein the base comprises a plurality of fixed pins,
each of the plurality of blades comprises a rotation hole in which one of the plurality of moving pins is disposed, and
each of the plurality of blades comprises a guide hole in which one of the plurality of fixed pins is disposed.

25. The aperture module of claim 23, wherein the plurality of blades comprise a first blade, a second blade, a third blade, and a fourth blade,
the plurality of moving pins comprise two first moving pins disposed on the one side of the incident hole in the moving direction of the plurality of moving pins, and two second moving pins disposed on the opposite side of the incident hole in the moving direction of the plurality of moving pins,
a first one of the two first moving pin forms the rotation axis of the first blade,
a second one of the two first moving pins forms the rotation axis of the second blade,
a first one of the two second moving pins forms the rotation axis of the third blade,
a second one of the two second moving pins forms the rotation axis of the fourth blade,
the two first moving pins are spaced apart from each other in a direction perpendicular to the moving direction of the plurality of moving pins,
the two second moving pins are spaced apart from each other in a direction perpendicular to the moving direction of the plurality of moving pins, and
the two first moving pins and the two second moving pins do not overlap the incident hole in the moving direction of the plurality of moving pins.

26. The aperture module of claim 23, wherein the plurality of blades comprise a first blade, a second blade, a third blade, and a fourth blade,
the plurality of moving pins comprise a first moving pin disposed on the one side of the incident hole in the moving direction of the plurality of moving pins, and a second moving pin disposed on the opposite side of the incident hole in the moving direction of the plurality of moving pins,
the first moving pin forms the rotation axis of the first blade and the rotation axis of the second blade,
the second moving pin forms the rotation axis of the third blade and the rotation axis of the fourth blade, and
the first moving pin and the second moving pin overlap the incident hole in the moving direction of the plurality of moving pins.
